(19) United States
(12) Patent Application Publication
(10) Pub. No.: US 2026/0046769 A1
(43) Pub. Date: Feb. 12, 2026

(54) LOW-POWER WAKE-UP SIGNALS FOR PDCCH MONITORING

(71) Applicant: QUALCOMM Incorporated, San Diego, CA (US)

(72) Inventors: Shijun WU, San Diego, CA (US); Huilin XU, Temecula, CA (US); Nicolas CORNILLET, LANNION (FR)

(21) Appl. No.: 19/214,757

(22) Filed: May 21, 2025

Related U.S. Application Data
(60) Provisional application No. 63/680,968, filed on Aug. 8, 2024.

(51) Int. Cl. H04W 52/02; H04L 5/00

(52) U.S. Cl. CPC H04W 52/0235; H04L 5/0053

(57) ABSTRACT

Methods, systems, and devices for wireless communications are described. A user equipment (UE) may identify (e.g., via a standard, control signaling from a network entity, or both) a configuration that indicates to cycle between a first power state and a second power state, and indicates (e.g., via one or more parameters) a first subset of multiple control channels that the UE is triggered by a low-power wake-up signal (LP-WUS) to monitor during the first power state. The first power state may be associated with higher power consumption than the second power state. The UE may receive the LP-WUS that triggers the UE to monitor the first subset of the multiple control channels based on the configuration. The UE may monitor, using the first power state, the first subset of the multiple control channels for one or more control messages based on the configuration and reception of the LP-WUS.

### CROSS REFERENCES

The present Application for Patent claims benefit of U.S. Provisional Ser. No. 63/680,968 by WU et al., entitled “LOW-POWER WAKE-UP SIGNALS FOR PDCCH MONITORING,” filed Aug. 8, 2024, assigned to the assignee hereof, and expressly incorporated herein.

### FIELD OF TECHNOLOGY

The following relates to wireless communications, including low-power wake-up signals (LP-WUSs) for PDCCH monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, based on a configuration, a low-power wake-up signal (LP-WUS) that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state and monitoring, using the first power state and based on the configuration and reception of the LP-WUS, the first subset of the set of multiple control channels for one or more control messages.

A UE for wireless communications is described. The UE may include one or more processors, one or more memories coupled with the one or more processors, and one or more processor-readable instructions stored in the one or more memories. The one or more processor-readable instructions may be executable by the one or more processors individually or collectively to cause the UE to receive, based on a configuration, an LP-WUS that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state and monitor, using the first power state and based on the configuration and reception of the LP-WUS, the first subset of the set of multiple control channels for one or more control messages.

Another UE for wireless communications is described. The UE may include means for receiving, based on a configuration, an LP-WUS that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state and means for monitoring, using the first power state and based on the configuration and reception of the LP-WUS, the first subset of the set of multiple control channels for one or more control messages.

A non-transitory computer-readable medium storing code for wireless communications is described. The code may include instructions executable by one or more processors to receive, based on a configuration, an LP-WUS that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state and monitor, using the first power state and based on the configuration and reception of the LP-WUS, the first subset of the set of multiple control channels for one or more control messages.

Some examples of the method, UEs, and non-transitory computer-readable medium described herein may further include operations, features, means, or instructions for receiving control signaling that indicates the configuration, where the LP-WUS may be received based on reception of the control signaling, and where the first subset of the set of multiple control channels may be monitored based on reception of the control signaling.

Some examples of the method, UEs, and non-transitory computer-readable medium described herein may further include operations, features, means, or instructions for identifying a first configuration that indicates the first subset of the set of multiple control channels that the UE may be triggered by the LP-WUS to monitor during the first power state and receiving control signaling that indicates a second configuration, where the second configuration indicates a second subset of the set of multiple control channels that the UE may be triggered by the LP-WUS or a second LP-WUS to monitor during the first power state.

In some examples of the method, UEs, and non-transitory computer-readable medium described herein, the first subset of the set of multiple control channels and the second subset of the set of multiple control channels include one or more control channels in common and the second configuration overwrites the first configuration, or both.

In some examples of the method, UEs, and non-transitory computer-readable medium described herein, the first configuration indicates a first set of one or more parameters and the second configuration indicates a second set of one or more parameters.

In some examples of the method, UEs, and non-transitory computer-readable medium described herein, the configuration indicates one or more control resource set (CORESET) identifiers (IDs) and the first subset of the set of multiple control channels may be based on the one or more CORESET IDs.

In some examples of the method, UEs, and non-transitory computer-readable medium described herein, the configuration indicates one or more search space sets and the first subset of the set of multiple control channels may be based on the one or more search space sets.

In some examples of the method, UEs, and non-transitory computer-readable medium described herein, the configuration indicates one or more search space set types and the first subset of the set of multiple control channels may be based on the one or more search space set types.

In some examples of the method, UEs, and non-transitory computer-readable medium described herein, the configuration indicates one or more radio network temporary identifier (RNTI) types and the first subset of the set of multiple control channels may be based on the one or more RNTI types.

In some examples of the method, UEs, and non-transitory computer-readable medium described herein, the configuration indicates one or more control message formats and the first subset of the set of multiple control channels may be based on the one or more control message formats.

In some examples of the method, UEs, and non-transitory computer-readable medium described herein, the configuration indicates one or more parameters, the first subset of the set of multiple control channels may be based on the one or more parameters, and the one or more parameters include one or more CORESET IDs, one or more search space sets, one or more search space set types, one or more RNTI types, one or more control message formats, or a combination thereof.

In some examples of the method, UEs, and non-transitory computer-readable medium described herein, the first subset of the set of multiple control channels may be a single control channel.

A method for wireless communications by a network entity is described. The method may include outputting, based on a configuration, an LP-WUS associated with triggering a UE to monitor a first subset of a set of multiple control channels, where the configuration may indicate the UE to cycle between a first power state and a second power state, and may indicate the first subset of the plurality of control channels that the UE is to monitor during the first power state, and where the first power state may be associated with higher power consumption than the second power state, and outputting, based on the configuration and the LP-WUS, one or more control messages via the first subset of the set of multiple control channels.

A network entity for wireless communications is described. The network entity may include one or more processors, one or more memories coupled with the one or more processors, and one or more processor-readable instructions stored in the one or more memories. The one or more processor-readable instructions may be executable by the one or more processors individually or collectively to cause the network entity to output, based on a configuration, an LP-WUS associated with triggering a UE to monitor a first subset of a set of multiple control channels, where the configuration may indicate the UE to cycle between a first power state and a second power state, and may indicate the first subset of the plurality of control channels that the UE is to monitor during the first power state, and where the first power state may be associated with higher power consumption than the second power state, and output, based on the configuration and the LP-WUS, one or more control messages via the first subset of the set of multiple control channels.

Another network entity for wireless communications is described. The network entity may include means for outputting, based on a configuration, an LP-WUS associated with triggering a UE to monitor a first subset of a set of multiple control channels, where the configuration may indicate the UE to cycle between a first power state and a second power state, and may indicate the first subset of the plurality of control channels that the UE is to monitor during the first power state, and where the first power state may be associated with higher power consumption than the second power state, and means for outputting, based on the configuration and the LP-WUS, one or more control messages via the first subset of the set of multiple control channels.

A non-transitory computer-readable medium storing code for wireless communications is described. The code may include instructions executable by one or more processors to output, based on a configuration, an LP-WUS associated with triggering a UE to monitor a first subset of a set of multiple control channels, where the configuration may indicate the UE to cycle between a first power state and a second power state, and may indicate the first subset of the plurality of control channels that the UE is to monitor during the first power state, and where the first power state may be associated with higher power consumption than the second power state, and output, based on the configuration and the LP-WUS, one or more control messages via the first subset of the set of multiple control channels.

Some examples of the method, network entities, and non-transitory computer-readable medium described herein may further include operations, features, means, or instructions for outputting control signaling that indicates the configuration, where the LP-WUS may be output based on the control signaling, and where the one or more control messages may be output via the first subset of the set of multiple control channels based on the control signaling.

Some examples of the method, network entities, and non-transitory computer-readable medium described herein may further include operations, features, means, or instructions for identifying a first configuration that indicates the first subset of the set of multiple control channels that the UE may be triggered by the LP-WUS to monitor during the first power state and outputting control signaling that indicates a second configuration, where the second configuration indicates a second subset of the set of multiple control channels that the UE may be triggered by the LP-WUS to monitor during the first power state.

In some examples of the method, network entities, and non-transitory computer-readable medium described herein, the first subset of the set of multiple control channels and the second subset of the set of multiple control channels include one or more control channels in common and the second configuration overwrites the first configuration, or both.

In some examples of the method, network entities, and non-transitory computer-readable medium described herein, the first configuration indicates a first set of one or more parameters and the second configuration indicates a second set of one or more parameters.

In some examples of the method, network entities, and non-transitory computer-readable medium described herein, the configuration indicates one or more CORESET IDs and the first subset of the set of multiple control channels may be based on the one or more CORESET IDs.

Some examples of the method, network entities, and non-transitory computer-readable medium described herein may further include operations, features, means, or instructions for transmitting control signaling indicating a parameter for one or more CORESETs, the parameter indicating that one or more control channels associated with the one or more CORESETs may be included in the first subset of the set of multiple control channels.

In some examples of the method, network entities, and non-transitory computer-readable medium described herein, the configuration indicates one or more search space sets and the first subset of the set of multiple control channels may be based on the one or more search space sets.

In some examples of the method, network entities, and non-transitory computer-readable medium described herein, the configuration indicates one or more search space set types and the first subset of the set of multiple control channels may be based on the one or more search space set types.

In some examples of the method, network entities, and non-transitory computer-readable medium described herein, the configuration indicates one or more RNTI types and the first subset of the set of multiple control channels may be based on the one or more RNTI types.

In some examples of the method, network entities, and non-transitory computer-readable medium described herein, the configuration indicates one or more control message formats and the first subset of the set of multiple control channels may be based on the one or more control message formats.

In some examples of the method, network entities, and non-transitory computer-readable medium described herein, the configuration indicates one or more parameters, the first subset of the set of multiple control channels may be based on the one or more parameters, and the one or more parameters include one or more CORESET IDs, one or more search space sets, one or more search space set types, one or more RNTI types, one or more control message formats, or a combination thereof.

In some examples of the method, network entities, and non-transitory computer-readable medium described herein, the first subset of the set of multiple control channels may be a single control channel.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low-power wake-up signals (LP-WUSs) for PDCCH monitoring in accordance with one or more aspects of the present disclosure.

FIG. 2 shows an example of a wireless communications system that supports LP-WUSs for PDCCH monitoring in accordance with one or more aspects of the present disclosure.

FIGS. 3A and 3B show examples of timing diagrams that support LP-WUSs for PDCCH monitoring in accordance with one or more aspects of the present disclosure.

FIG. 4 shows an example of a process flow that supports LP-WUSs for PDCCH monitoring in accordance with one or more aspects of the present disclosure.

FIGS. 5 and 6 show block diagrams of devices that support LP-WUSs for PDCCH monitoring in accordance with one or more aspects of the present disclosure.

FIG. 7 shows a block diagram of a communications manager that supports LP-WUSs for PDCCH monitoring in accordance with one or more aspects of the present disclosure.

FIG. 8 shows a diagram of a system including a device that supports LP-WUSs for PDCCH monitoring in accordance with one or more aspects of the present disclosure.

FIGS. 9 and 10 show block diagrams of devices that support LP-WUSs for PDCCH monitoring in accordance with one or more aspects of the present disclosure.

FIG. 11 shows a block diagram of a communications manager that supports LP-WUSs for PDCCH monitoring in accordance with one or more aspects of the present disclosure.

FIG. 12 shows a diagram of a system including a device that supports LP-WUSs for PDCCH monitoring in accordance with one or more aspects of the present disclosure.

FIGS. 13 through 18 show flowcharts illustrating methods that support LP-WUSs for PDCCH monitoring in accordance with one or more aspects of the present disclosure.

### DETAILED DESCRIPTION

In some wireless communications systems, a network entity may transmit a low-power wake-up signal (LP-WUS) to a user equipment (UE) to trigger physical downlink control channel (PDCCH) monitoring at the UE. When the UE is in a connected mode, reception of the LP-WUS may trigger the UE to monitor for all configured PDCCHs. For example, the UE may refrain from monitoring any configured PDCCHs in the absence of the LP-WUS and may monitor all configured PDCCHs in the presence of the LP-WUS. In such cases, the network entity may double the resources and energy for sending control information, because the network entity may transmit the LP-WUS in order to transmit a PDCCH. Because the LP-WUS uses a non-coherent on-off keying (OOK) modulation, the LP-WUS may use additional resources to enable a lower data rate for the UE to successfully detect the LP-WUS. Moreover, transmitting an LP-WUS for every PDCCH to be transmitted may cause additional latency. Additionally, some PDCCHs (e.g., scheduling PDCCH for high traffic characteristics, PDCCHs for some broadcast messages, and UE-common PDCCHs) may not be suitable for LP-WUS-triggered monitoring. Thus, it may be desirable to restrict the PDCCHs that are triggered by the LP-WUS.

According to some aspects described herein, a UE may identify (e.g., via a standard, via a control message received from a network entity, or via both) a configuration that indicates to cycle between a relatively high power consumption state and a relatively low power consumption state. The configuration may also indicate a subset of control channels (e.g., PDCCHs) that the UE is triggered by an LP-WUS to monitor during the high power consumption state. For example, the configuration may indicate one or more parameters that identify the subset of PDCCHs. The one or more parameters may include one or more control resource set (CORESET) identifiers (IDs), one or more search space sets, one or more search space set types, one or more radio network temporary identifier (RNTI) types, one or more control message formats (e.g., downlink control information (DCI) formats), or a combination thereof. For example, the UE may receive a configuration identifying one or more PDCCHs associated with DCI format 1_0 and DCI format 1_1 in a first CORESET indicated by a first CORESET ID. Based on the configuration, the UE may be triggered by the LP-WUS to monitor for the one or more PDCCHs indicated by the configuration.

Particular aspects of the subject matter described herein may be implemented to realize one or more potential advantages. The described techniques may provide for reduced processing, reduced power consumption, reduced latency, improved user experience related to reduced processing, more efficient utilization of communication resources, improved coordination between devices, and longer battery life. For example, the UE may reduce power consumption by monitoring a subset of control channels (e.g., control channels that are suitable for LP-WUS-monitored triggering, such as delay-tolerant PDCCHs used for UE-specific data scheduling with sparse traffic) rather than a larger set of control channels (e.g., including one or more control channels that may not be suitable for LP-WUS-triggered monitoring, such as PDCCHs for broadcast and UE-common PDCCH) in response to the LP-WUS. Additionally, or alternatively, the network entity may reduce power consumption by outputting fewer LP-WUSs relative to other techniques.

Aspects of the disclosure are initially described in the context of wireless communications systems. Aspects of the disclosure are then described in the context of timing diagrams and a process flow. Aspects of the disclosure are further illustrated by and described with reference to apparatus diagrams, system diagrams, and flowcharts that relate to LP-WUSs for PDCCH monitoring.

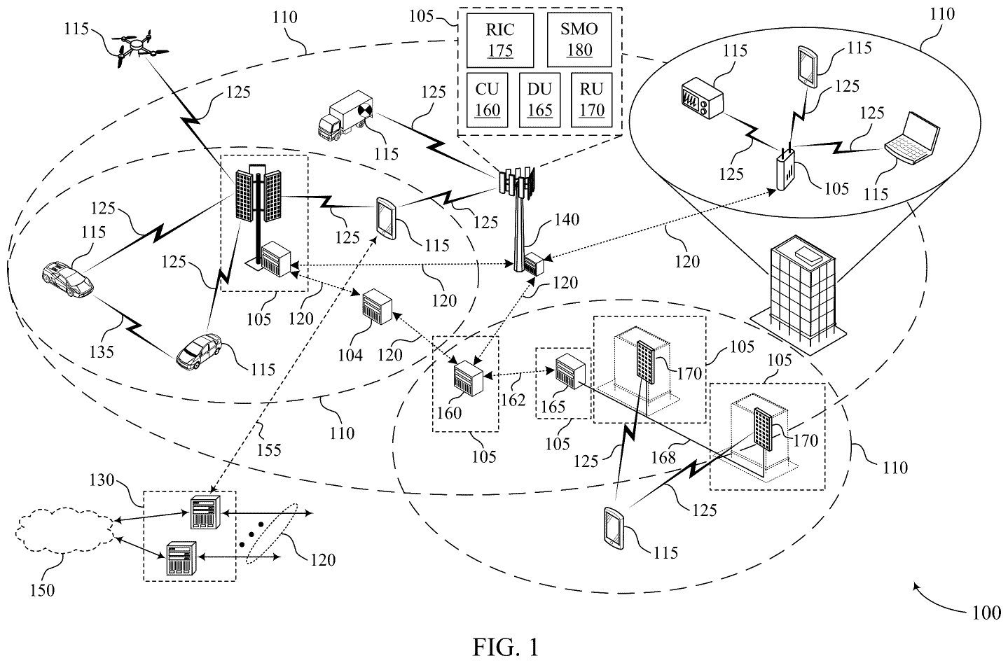

FIG. 1 shows an example of a wireless communications system 100 that supports LP-WUSs for PDCCH monitoring in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a network entity 105 may transmit, via a communication link 125, an LP-WUS to a UE 115 to trigger PDCCH monitoring at the UE 115. When the UE 115 is in a connected mode, reception of the LP-WUS may trigger the UE 115 to monitor for all configured PDCCHs. For example, the UE 115 may refrain from monitoring any configured PDCCHs in the absence of the LP-WUS and may monitor all configured PDCCHs in the presence of the LP-WUS. In such cases, the network entity 105 may double the resources and energy for sending control information, because the network entity 105 may transmit the LP-WUS in order to transmit a PDCCH. Because the LP-WUS uses a non-coherent OOK modulation, the LP-WUS may use additional resources to enable a lower data rate for the UE 115 to successfully detect the LP-WUS. Moreover, transmitting an LP-WUS for every PDCCH to be transmitted may cause additional latency. Additionally, some PDCCHs (e.g., scheduling PDCCH for high traffic characteristics, PDCCHs for some broadcast messages, and UE-common PDCCHs) may not be suitable for LP-WUS-triggered monitoring. Thus, it may be desirable to restrict the PDCCHs that are triggered by the LP-WUS.

In the wireless communications system 100, a UE 115 may identify (e.g., via a standard, via a control message received from a network entity 105, or via both) a configuration that indicates to cycle between a relatively high power consumption state and a relatively low power consumption state. The configuration may also indicate a subset of control channels (e.g., PDCCHs) that the UE 115 is triggered by an LP-WUS to monitor during the high power consumption state. For example, the configuration may indicate one or more parameters that identify the subset of PDCCHs. The one or more parameters may include one or more CORESET IDs, one or more search space sets, one or more search space set types, one or more RNTI types, one or more control message formats (e.g., DCI formats), or a combination thereof. For example, the UE 115 may receive a configuration identifying one or more PDCCHs associated with DCI format 1_0 and DCI format 1_1 in a first CORESET indicated by a first CORESET ID. Based on the configuration, the UE 115 may be triggered by the LP-WUS to monitor for the one or more PDCCHs indicated by the configuration.

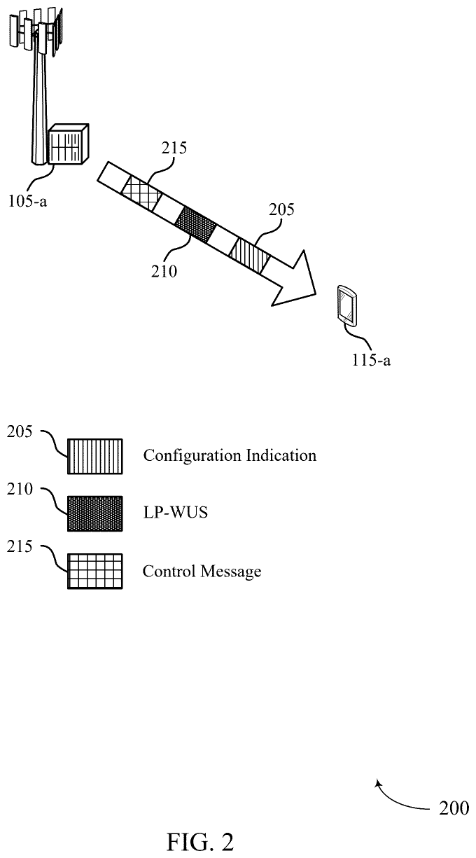

FIG. 2 shows an example of a wireless communications system 200 that supports LP-WUSs for PDCCH monitoring in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115-and a network entity 105, it is understood that the described techniques may be performed by a wireless device different from a UE 115-and a network entity 105. As described herein, operations performed by the UE 115-a and the network entity 105-a may be respectively performed by a UE 115, a network entity 105, or another wireless device, and the examples shown should not be construed as limiting.

In some examples, a network entity 105 may output or transmit a wake-up signal to a UE 115 to trigger the UE 115 to monitor one or more control channels (e.g., one or more PDCCHs). A wake-up signal may be termed a low-power wake-up signal (LP-WUS) when the signaling design considers a relatively simple receiver architecture, and may be associated with a basic modulation scheme of on-off keying (OOK). That is, the UE 115 may include at least two radios: a main radio and a low-power wake-up radio (LP-WUR) (e.g., an envelope detector). The LP-WUR may be simplified receiver circuitry that the UE 115 may use to monitor for and detect an LP-WUS. Since the LP-WUR may lack one or more other receiving capabilities and consume less power, the UE 115 may save power by operating in a relatively low power state (e.g., a first power state) using the LP-WUR without operating more power-intensive circuitry. In contrast, the UE 115 may use the main radio while in a relatively high power state (e.g., a second power state) to increase receive functionality at the cost of increased power consumption, such as for monitoring for PDCCH and PDSCH transmissions. In some examples, the network entity 105 may trigger (e.g., by sending an LP-WUS) the UE 115 to transition from the first power state to the second power state (e.g., wake up by transitioning from using the LP-WUR to using the main radio) to monitor one or more PDCCHs while the UE 115 is in an idle or inactive mode or while the UE 115 is in a connected mode. Devices in the wireless communications system 200 may support LP-WUS-triggered PDCCH monitoring while the UE 115-a is in the connected mode.

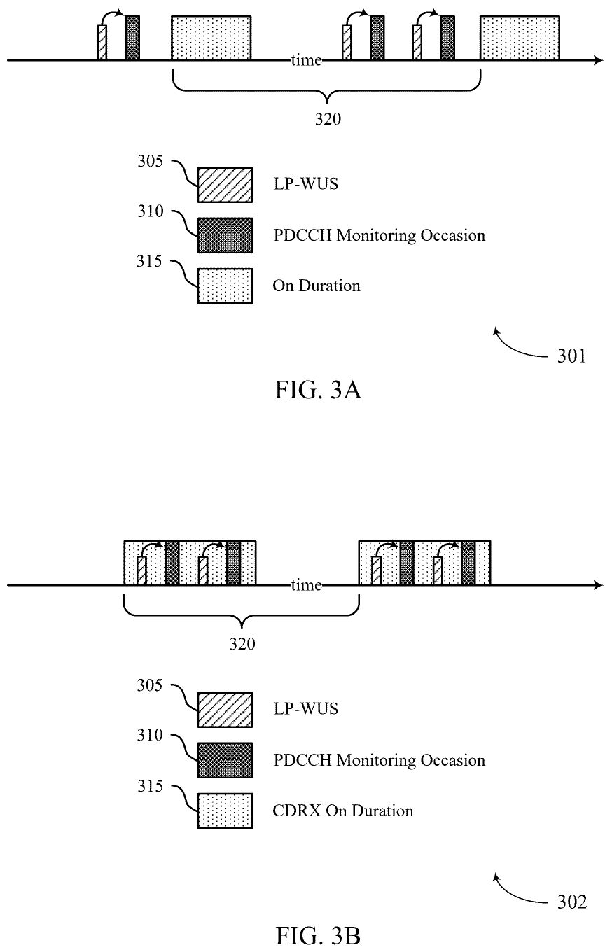

Devices in the wireless communications system 200 may support several options for PDCCH monitoring while the UE 115-a is in the connected mode. In a first option, the UE 115-a may monitor for the LP-WUS 210 at a time before a connected-mode discontinuous reception (CDRX) on-duration to indicate whether the UE 115-a is to enter the on-duration. For example, this may replace a PDCCH wake-up signal (e.g., a DCI power saving (DCP) signal or a DCI-based wake-up signal). In a second option, the UE 115-a may monitor for the LP-WUS 210 outside a CDRX active time (e.g., on-duration) to trigger PDCCH monitoring (e.g., as illustrated by FIG. 3A). This option may reduce data scheduling latency and may allow CDRX to occur outside of the CDRX active time if the CDRX is triggered by the LP-WUS 210. In a third option, the UE 115-a may monitor for the LP-WUS 210 inside (e.g., within) the CDRX active time to trigger PDCCH monitoring (e.g., as illustrated by FIG. 3B).

In relatively simple designs for the second option and the third option, the LP-WUS 210 may trigger the UE 115-a to monitor all configured PDCCHs while in the connected mode. In the simple design, the UE 115-a may refrain from monitoring any (e.g., all) configured PDCCHs if the LP-WUS 210 is not successfully received. This implies that the network entity 105-a doubles the resources and energy for sending control information. For example, whenever the network entity 105-a outputs (e.g., transmits, sends) a PDCCH to the UE 115-a, the network entity 105-a first outputs the LP-WUS 210. In some cases, the simple design may incur more resource usage when the LP-WUS 210 uses non-coherent OOK modulation, since further resources may enable a lower data rate for the UE 115-a to successfully detect the LP-WUS 210. Additionally, or alternatively, the simple design may result in increased latency caused by the LP-WUS 210 for every PDCCH.

Thus, it may be desirable to restrict the PDCCHs that the UE 115-a is triggered by the LP-WUS 210 to monitor. In some implementations, monitoring of a first subset of control channels (e.g., PDCCHs) may be triggered by the LP-WUS 210 and monitoring of a second subset of control channels may occur during the CDRX active time. In some examples, restricting the control channels that the UE 115-a is triggered by the LP-WUS 210 to monitor may allow the network entity 105-a to have flexible control of the PDCCH triggering by the LP-WUS 210 for network energy savings. Moreover, some control channels may not be suitable for LP-WUS-triggered monitoring. For example, PDCCHs used for UE-specific data scheduling with sparse traffic and that are delay-tolerant may be relatively suitable for LP-WUS triggering in connected mode, while other PDCCHs (e.g., scheduling PDCCHs for other traffic characteristics, PDCCHs for broadcasts, and UE-common PDCCHs) may not be suitable or desirable to be triggered by the LP-WUS 210.

In some implementations, the UE 115-a may identify a configuration that indicates to cycle between a first power state and a second power state, and that indicates a first subset of control channels from a set of multiple control channels (e.g., PDCCHs) that the UE 115-a is triggered by the LP-WUS 210 to monitor during the first power state. The first power state may be associated with higher power consumption at the UE 115-a than the second power state. The configuration may identify the subset of control channels by indicating one or more parameters, where the parameters may include one or more CORESET IDs, one or more search space sets, one or more search space set types (e.g., common or UE-specific), one or more RNTI types, one or more control message formats, or a combination thereof. The network entity 105-a may output one or more control messages 215 via one or more control channels of the first subset of control channels.

In some examples, the network entity 105-a may configure the first subset of control channels that the UE 115-a is triggered by the LP-WUS 210 to monitor, and the UE 115-a may identify the configuration based on receiving a configuration indication 205 from the network entity 105-a. Additionally, or alternatively, the UE 115-a may identify the configuration via a standard (e.g., a 3rd Generation Partnership Project (3GPP) specification). In some examples, the UE 115-a may identify a first configuration (e.g., indicating a first subset of control channels via a first set of one or more parameters) via a standard and may identify a second configuration (e.g., indicating a second subset of control channels via a second set of one or more parameters) via the configuration indication 205. The UE 115-a may be triggered by the LP-WUS 210 to monitor the first subset of control channels by default. In some cases, the first subset of control channels (e.g., identified via the standard) and the second subset of control channels (e.g., identified via the configuration indication 205) may at least partially overlap (e.g., have at least one control channel in common). In such cases, the second configuration (e.g., associated with the second subset of control channels) may overwrite the first configuration (e.g., associated with the first subset of control channels).

In some examples, the first subset of control channels may be identified by CORESET. The network entity 105-a may configure the UE 115-a with multiple CORESETs, and each CORESET may be identified by a CORESET ID (e.g., ControlResourceSetId in RRC). PDCCH monitoring triggered by the LP-WUS 210 may be CORESET-specific, as different CORESETs may have different bandwidths, and thus may be associated with different amounts of power consumption for decoding PDCCHs. For example, the network entity 105-a may indicate, via the configuration indication 205, one or more CORESET IDs to the UE 115-a. The UE 115-a may be triggered by the LP-WUS 210 to monitor one or more control channels within one or more CORESETs associated with the one or more CORESET IDs. In another example, the network entity 105-a may configure one or more CORESETs with a new parameter that may indicate whether monitoring of one or more control channels within the one or more CORESETs would be triggered by the LP-WUS 210. For example, the new parameter may be added to a first CORESET to indicate that the monitoring of one or more control channels within the first CORESET is to be triggered by the LP-WUS 210.

In some examples, the first subset of control channels may be identified by search space set or by search space set type. The UE 115-a may be configured with one or more search space sets, including UE-specific search space sets, common search space sets, or both. In some cases, the network entity 105-a may indicate, via the configuration indication 205, whether the UE 115-a is triggered by the LP-WUS 210 to monitor one or more control channels in a first search space set (e.g., the first configuration is a search space set-specific LP-WUS triggering configuration). Additionally, or alternatively, the network entity 105-a may indicate, via the configuration indication 205, whether the UE 115-a is triggered by the LP-WUS 210 to monitor one or more control channels in one or more search space sets of a first search space set type (e.g., UE-specific or common). Additionally, or alternatively, a standard may specify that the UE 115-a may be triggered by the LP-WUS 210 to monitor one or more control channels in one or more search space set of a first search space set type (e.g., UE-specific or common).

In some examples, the first subset of control channels may be identified by a RNTI type. The UE 115-a may be configured with one or more RNTI types (e.g., cell RNTI (C-RNTI), configured scheduling RNTI (CS-RNTI), modulation and coding scheme RNTI (MCS-RNTI), other RNTI types, or a combination thereof). The UE 115-a may be triggered by the LP-WUS 210 to monitor one or more control channels scrambled by one or more RNTI types indicated by a configuration. For example, the network entity 105-a may indicate, via the configuration indication 205, whether the UE 115-a is triggered by the LP-WUS 210 to monitor one or more control channels scrambled by C-RNTI or CS-RNTI (e.g., or another RNTI type or combination of RNTI types). The configuration indication 205 may indicate C-RNTI and CS-RNTI because these are the UE-specific RNTIs that are commonly used for scheduling shared channel (e.g., PDSCH and PUSCH) transmissions. Control channels scrambled by a RNTI type other than C-RNTI or CS-RNTI (e.g., by MCS-RNTI) may not be suitable for LP-WUS triggering (e.g., because MCS-RNTI may be used for URLLC applications). Additionally, or alternatively, a standard may specify that the UE 115-a is triggered by the LP-WUS 210 to monitor one or more control channels scrambled by C-RNTI or CS-RNTI. In some cases, the standards may specify that the UE 115-a is triggered by the LP-WUS 210 to monitor one or more control channels scrambled by UE-specific RNTI (e.g., including C-RNTI, CS-RNTI, other UE-specific RNTI, or a combination thereof).

In some examples, the first subset of control channels may be identified by a control message format (e.g., a DCI format). For example, the network entity 105-a may indicate, via the configuration indication 205, whether the UE 115-a is triggered by the LP-WUS 210 to monitor one or more control channels with DCI format 1_0 and DCI format 1_1 (e.g., DCI formats used for PDSCH scheduling). In another example, the network entity 105-a may indicate, via the configuration indication 205, whether the UE 115-a is triggered by the LP-WUS 210 to monitor one or more control channels with DCI format 0_0, DCI format 0_1, DCI format 1_0 and DCI format 1_1 (e.g., DCI formats used for PDSCH and PUSCH scheduling). Additionally, or alternatively, a standard may specify that the UE 115-a is triggered by the LP-WUS 210 to monitor one or more control channels with DCI format 1_0 and DCI format 1_1. Similarly, in another example, the standard may specify that the UE 115-a is triggered by the LP-WUS 210 to monitor one or more control channels with DCI format 0_0, DCI format 0_1, DCI format 1_0 and DCI format 1_1.

In some examples, the first subset of control channels may be identified by a combination of two or more parameters. The parameters may correspond to any combination of CORESET, SS set, SS set type, RNTI type, DCI format, as discussed above and herein. For example, the combination of two or more parameters may be indicated by the configuration indication 205, or the combination of two or more parameters may be specified in one or more standards. In a first example, the network entity 105-a may indicate, via the configuration indication 205, whether the UE 115-a is triggered by the LP-WUS 210 to monitor one or more control channels with DCI format 1_0 and DCI format 1_1 in a first CORESET. In a second example, the network entity 105-a may indicate, via the configuration indication 205, whether the UE 115-a is triggered by the LP-WUS 210 to monitor one or more control channels scrambled by C-RNTI in a first CORESET. In a third example, a standard may specify that the UE 115-a is triggered by the LP-WUS 210 to monitor one or more control channels with DCI format 1_0 and DCI format 1_1 in a UE-specific search space set. In a fourth example, a standard may specify that the UE 115-a is triggered by the LP-WUS 210 to monitor one or more control channels scrambled by C-RNTI in a UE-specific search space set.

Additionally, or alternatively, a first subset of parameters in the combination of two or more parameters may be configured by the network entity 105-a while a second subset of parameters in the combination of two or more parameters may be specified in one or more standards. For example, a standard may specify that UE 115-a is triggered by the LP-WUS 210 to monitor one or more control channels with DCI format 1_0 and DCI format 1_1 (e.g., limiting the first subset of control channels to include control channels with those control message formats). The network entity 105-a may further indicate, via the configuration indication 205, one or more CORESETs that the triggering is applicable to (e.g., further limiting the first subset of control channels to those in a first subset of CORESETs). In another example, a standard may specify that UE 115-a is triggered by the LP-WUS 210 to monitor one or more control channels scrambled by C-RNTI, and the network entity 105-a may further indicate, via the configuration indication 205, one or more CORESETs that the triggering is applicable to.

FIGS. 3A and 3B show examples of timing diagrams 301 and 302 that support LP-WUSs for PDCCH monitoring in accordance with one or more aspects of the present disclosure. The timing diagrams 301 and 302 may implement or be implemented by one or more aspects of the wireless communications system 100 and the wireless communications system 200 described with reference to FIGS. 1 and 2, respectively. For example, the timing diagrams 301 and 302 may be implemented by a network entity 105 and a UE 115 as described with reference to FIGS. 1 and 2 to support reduced PDCCH monitoring triggered by an LP-WUS.

For example, the timing diagram 301 and the timing diagram 302 illustrate a UE 115 receiving, from a network entity 105, an LP-WUS 305 that triggers the UE 115 to monitor one or more control channels associated with a PDCCH monitoring occasion 310. The UE 115 may be in a connected mode, and may be configured to enter a relatively high power state during the on duration 315 (e.g., a CDRX on duration) of the DRX cycle 320. The UE 115 may be in a relatively low power state (e.g., associated with a relatively simple receiver architecture) outside of the on duration 315.

For example, in the timing diagram 301, the UE 115 may be in the relatively low power state outside of the on duration 315 while monitoring for and receiving the LP-WUS 305 and during the PDCCH monitoring occasion 310 triggered by the LP-WUS 305. That is, the UE 115 may utilize an LP-WUR such as an envelope detector while in the relatively low power state. In contrast, in the timing diagram 302, the UE 115 may be in the relatively high power state (e.g., utilizing a relatively high-power radio or receiver, such as the main radio) within the on duration 315 while monitoring for and receiving the LP-WUS 305 and during the PDCCH monitoring occasion 310 triggered by the LP-WUS 305.

In relatively simple designs for the timing diagram 301 and the timing diagram 302, the LP-WUS 305 may trigger the UE 115 to monitor all configured control channels (e.g., PDCCHs) while in the connected mode. In the simple design, the UE 115 may refrain from monitoring any (e.g., all) configured PDCCHs if the LP-WUS 305 is not successfully received. This implies that the network entity 105 doubles the resources and energy for sending control information. For example, whenever the network entity 105 outputs (e.g., transmits, sends) a PDCCH to the UE 115, the network entity 105 first outputs the LP-WUS 305. In some cases, the simple design may incur more resource usage when the LP-WUS 305 uses non-coherent OOK modulation, since further resources may enable a lower data rate for the UE 115 to successfully detect the LP-WUS 305. Additionally, or alternatively, the simple design may result in increased latency caused by the LP-WUS 305 for every PDCCH.

Thus, it may be desirable to restrict the PDCCHs that the UE 115 is triggered by the LP-WUS 305 to monitor in the PDCCH monitoring occasion 310. In some implementations, monitoring of a first subset of control channels (e.g., PDCCHs) may be triggered by the LP-WUS 305 and monitoring of a second subset of control channels may occur during the on duration 315. In some examples, restricting the control channels that the UE 115 is triggered by the LP-WUS 305 to monitor may allow the network entity 105 to have flexible control of the PDCCH triggering by the LP-WUS 305 for network energy savings. Moreover, some control channels may not be suitable for LP-WUS-triggered monitoring. For example, PDCCHs used for UE-specific data scheduling with sparse traffic and that are delay-tolerant may be relatively suitable for LP-WUS triggering in connected mode, while other PDCCHs (e.g., scheduling PDCCHs for other traffic characteristics, PDCCHs for broadcasts, and UE-common PDCCHs) may not be suitable or desirable to be triggered by the LP-WUS 305.

In some implementations, the UE 115 may identify a configuration that indicates to cycle between a first power state (e.g., the relatively high power state) and a second power state (e.g., the relatively low power state), and that indicates a first subset of control channels from a set of multiple control channels (e.g., PDCCHs) that the UE 115 is triggered by the LP-WUS 305 to monitor during the first power state. The first power state may be associated with higher power consumption at the UE 115 than the second power state. The configuration may identify the subset of control channels by indicating one or more parameters, where the parameters may include one or more CORESET IDs, one or more search space sets, one or more search space set types (e.g., common or UE-specific), one or more RNTI types, one or more control message formats (e.g., DCI formats), or a combination thereof. The network entity 105 may output one or more control messages via one or more control channels of the first subset of control channels.

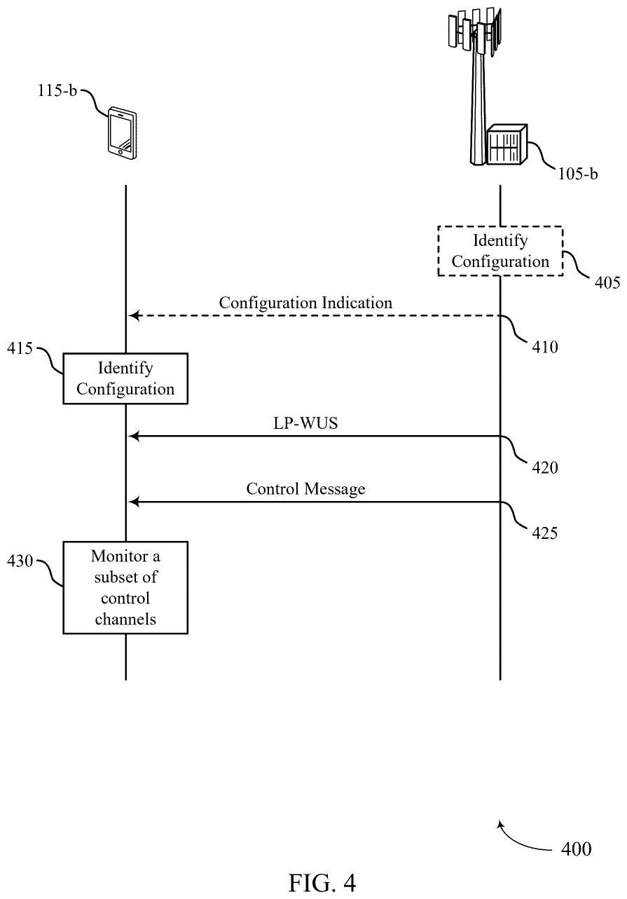

FIG. 4 shows an example of a process flow 400 that supports LP-WUSs for PDCCH monitoring in accordance with one or more aspects of the present disclosure. In some examples, the process flow 400 may be implemented by, or may implement aspects of, the wireless communications systems 100 and 200 and the timing diagrams 301 and 302. For example, the process flow 400 includes a network entity 105-b (e.g., a first wireless device) and a UE 115-b (e.g., a second wireless device), which may be examples of the corresponding devices described with reference to FIGS. 1 and 2. Following the process flow 400, the UE 115-b may perform an enhanced non-linearity correction procedure on a data signal. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

At 405, the network entity 105-b may identify a configuration that indicates the UE 115-b to cycle between a first power state and a second power state. The configuration may indicate a first subset of a set of multiple control channels that the UE 115-b is triggered by an LP-WUS (e.g., the LP-WUS at 420) to monitor during the first power state. The first power state may be associated with higher power consumption than the second power state. In some cases, the subset of the set of multiple control channels may be a single control channel (e.g., a single PDCCH). In some other cases, the subset of the set of multiple control channels may include multiple control channels (e.g., multiple PDCCHs).

At 410, the network entity 105-b may output (e.g., transmit), and the UE 115-b may receive, control signaling that indicates the configuration (e.g., may output a configuration indication). In other examples, the UE 115-b may access the configuration from, for example, memory, that stores the configuration when the UE 115-a complies with a particular standard.

At 415, the UE 115-b may identify the configuration. For example, the UE 115-b may identify the configuration based on receiving the control signaling from the network entity 105-b at 410 (e.g., by extracting the configuration indication from control signaling). Additionally, or alternatively, the UE 115-b may identify the configuration based on a standard (e.g., a 3GPP standard). For example, the UE 115-b may identify (e.g., via a standard) a first configuration that indicates (e.g., via a first set of parameters) the first subset of control channels that the UE 115-b is triggered by the LP-WUS to monitor during the first power state, and may receive control signaling (e.g., at 410) that indicates (e.g., via a second set of parameters) a second configuration. The second configuration may indicate a second subset of the set of multiple control channels that the UE 115-b is triggered by the LP-WUS at 410 or by a second LP-WUS to monitor during the first power state. For example, the first subset of control channels and the second subset of control channels may include one or more control channels in common. Additionally, or alternatively, the second configuration may overwrite the first configuration. In some examples, the first configuration may indicate a first set of one or more parameters and the second configuration may indicate a second set of one or more parameters.

The configuration (e.g., whether identified via a standard, via the control signaling at 410, or via both) may indicate one or more parameters that identify the subset of control channels that the UE 115-b is triggered by the LP-WUS to monitor during the first power state. For example, the configuration may indicate one or more CORESET IDs, where each CORESET ID is associated with at least one control channel that the UE 115-b is triggered by the LP-WUS to monitor. In some cases, the control signaling at 410 may indicate one or more CORESET IDs. In some cases, a parameter may be included in a CORESET configuration to indicate whether to monitor one or more control channels associated with the CORESET triggered by the LP-WUS. Additionally, or alternatively, the configuration may indicate one or more search space sets, where the UE 115-b is triggered by the LP-WUS to monitor one or more control channels associated with the indicated one or more search space sets. Additionally, or alternatively, the configuration may indicate one or more search space set types (e.g., common search space sets or UE-specific search space sets), such that the UE 115-b is triggered by the LP-WUS to monitor one or more control channels associated with the indicated one or more search space set types. For example, the network entity 105-b may indicate, via the control signaling at 410, that the UE 115-b is triggered to monitor one or more control channels associated with a common search space set in response to receiving the LP-WUS. Additionally, or alternatively, the configuration may indicate one or more RNTI types (e.g., C-RNTI, CS-RNTI, MCS-RNTI, another RNTI type, or a combination thereof), where the UE 115-b is triggered by the LP-WUS to monitor one or more control channels scrambled by the indicated one or more RNTI types. Additionally, or alternatively, the configuration may indicate one or more control message formats, where the UE 115-b is triggered by the LP-WUS to monitor one or more control channels associated with the indicated one or more control message formats. For example, the network entity 105-b may indicate, via the control signaling 410, whether the UE 115-b is triggered by the LP-WUS to monitor for one or more control channels with a DCI format 1_0 and for one or more control channels with a DCI format 1_1 (e.g., DCI formats used for PDSCH scheduling). As another example, the UE 115-b may identify, via a standard, that the UE 115-b is triggered by the LP-WUS to monitor for one or more control channels with a DCI format 0_0, DCI format 0_1, DCI form 1_0, and DCI format 1_1 (e.g., DCI formats used for PDSCH and PUSCH scheduling).

In some examples, the configuration may indicate multiple parameters that the UE 115-b is triggered by the LP-WUS to monitor. The one or more parameters may include any combination of one or more CORESET IDs, one or more search space sets, one or more search space set types, one or more RNTI types, and one or more control message formats. For example, the network entity 105-b may indicate, via the control signaling at 410, whether the UE 115-b is triggered by the LP-WUS to monitor one or more control channels with DCI format 1_0 and DCI format 1_1 in a first CORESET. In another example, the UE 115-b may identify a first set of parameters via the control signaling at 410 and may identify a second set of parameters via a standard. For example, a standard may specify that the UE 115-b is triggered by the LP-WUS to monitor one or more control channels with DCI format 1_0 and one or more control channels with DCI format 1_1, and the network entity 105-b may indicate, via the control signaling at 410, that the UE 115-b is triggered by the LP-WUS to monitor one or more control channels associated with a first CORESET. The UE 115-b may be triggered by the LP-WUS to monitor a subset of control channels based on the first set of parameters, based on the second set of parameters, or based on both.

At 420, the network entity 105-b may output, and the UE 115-b may receive, the LP-WUS that triggers the UE 115-b to monitor the first subset of control channels based on the configuration. In some examples, the UE 115-b may receive the LP-WUS based on the control signaling (e.g., the configuration indication) received at 410, based on the standard (e.g., indicating the configuration), or based on both the control signaling and based on the standard.

At 425, the network entity 105-b may output one or more control messages via the first subset of control channels based on the configuration and the LP-WUS.

At 430, the UE 115-b may monitor, using the first power state, the first subset of control channels for one or more control messages based on the configuration and reception of the LP-WUS. In some examples, the UE 115-b may monitor the first subset of control channels based on the control signaling received at 410, based on the standard, or based on both the control signaling and based on the standard.

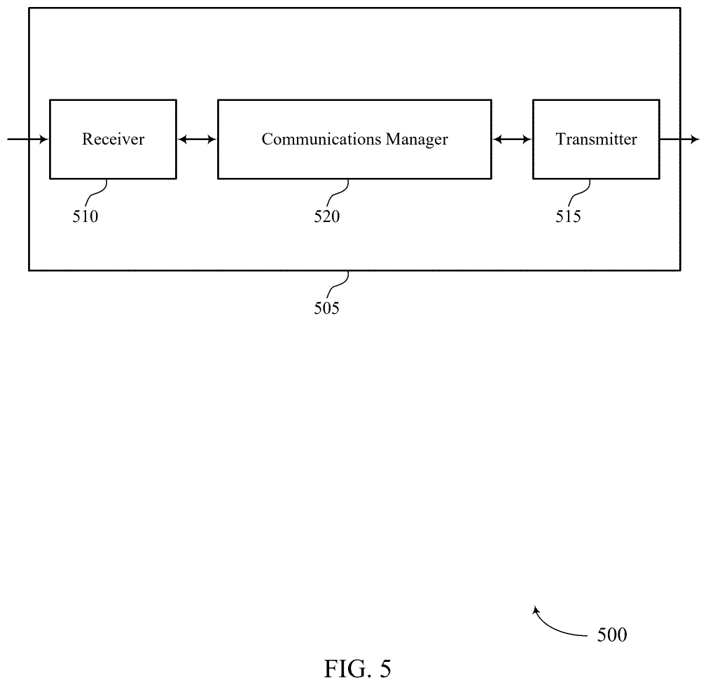

FIG. 5 shows a block diagram 500 of a device 505 that supports LP-WUSs for PDCCH monitoring in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to LP-WUSs for PDCCH monitoring). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LP-WUSs for PDCCH monitoring). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of LP-WUSs for PDCCH monitoring as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing one or more processor-readable instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for identifying a configuration that indicates to cycle between a first power state and a second power state, and indicates a first subset of a set of multiple control channels that the UE is triggered by an LP-WUS to monitor during the first power state, where the first power state is associated with higher power consumption than the second power state. The communications manager 520 is capable of, configured to, or operable to support a means for receiving the LP-WUS that triggers the UE to monitor the first subset of the set of multiple control channels based on the configuration. The communications manager 520 is capable of, configured to, or operable to support a means for monitoring, using the first power state, the first subset of the set of multiple control channels for one or more control messages based on the configuration and reception of the LP-WUS.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

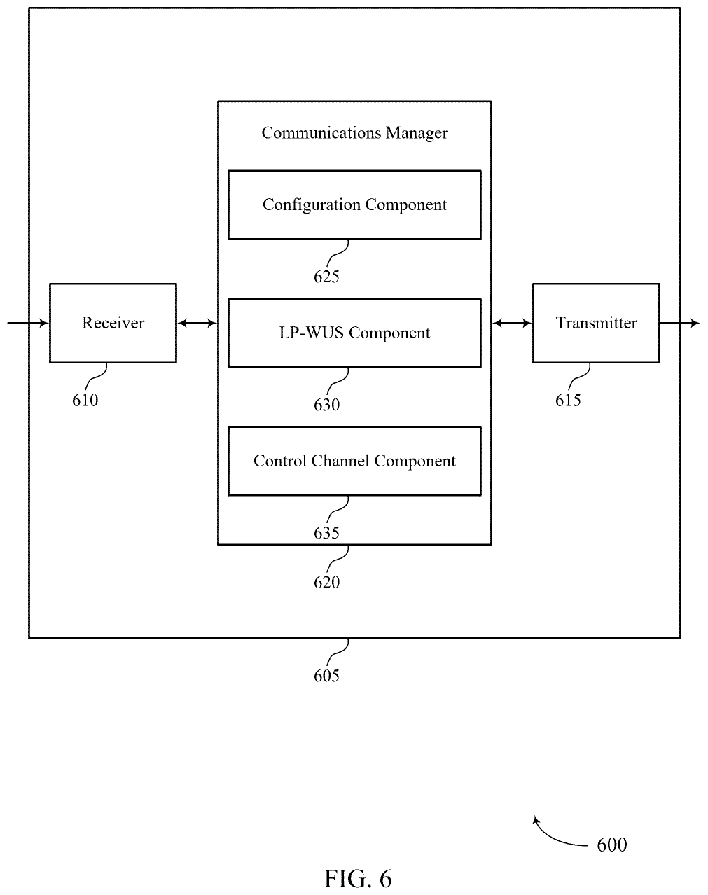

FIG. 6 shows a block diagram 600 of a device 605 that supports LP-WUSs for PDCCH monitoring in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to LP-WUSs for PDCCH monitoring). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LP-WUSs for PDCCH monitoring). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of LP-WUSs for PDCCH monitoring as described herein. For example, the communications manager 620 may include a configuration component 625, an LP-WUS component 630, a control channel component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for identifying a configuration that indicates to cycle between a first power state and a second power state, and indicates a first subset of a set of multiple control channels that the UE is triggered by an LP-WUS to monitor during the first power state, where the first power state is associated with higher power consumption than the second power state. The LP-WUS component 630 is capable of, configured to, or operable to support a means for receiving the LP-WUS that triggers the UE to monitor the first subset of the set of multiple control channels based on the configuration. The control channel component 635 is capable of, configured to, or operable to support a means for monitoring, using the first power state, the first subset of the set of multiple control channels for one or more control messages based on the configuration and reception of the LP-WUS.

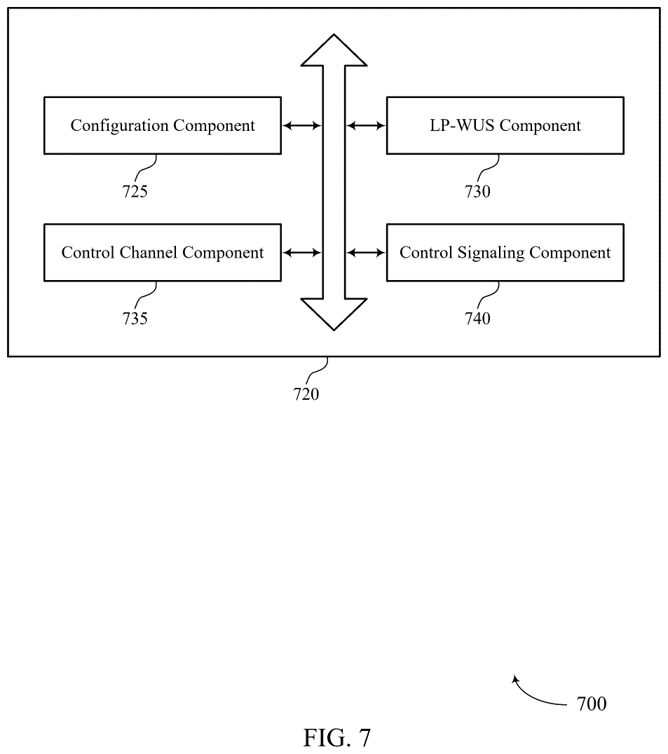

FIG. 7 shows a block diagram 700 of a communications manager 720 that supports LP-WUSs for PDCCH monitoring in accordance with one or more aspects of the present disclosure. The communications manager 720 may be an example of aspects of a communications manager 520, a communications manager 620, or both, as described herein. The communications manager 720, or various components thereof, may be an example of means for performing various aspects of LP-WUSs for PDCCH monitoring as described herein. For example, the communications manager 720 may include a configuration component 725, an LP-WUS component 730, a control channel component 735, a control signaling component 740, or any combination thereof. Each of these components, or components or subcomponents thereof (e.g., one or more processors, one or more memories, one or more processor-readable instructions), may communicate, directly or indirectly, with one another (e.g., via one or more buses).

The communications manager 720 may support wireless communications in accordance with examples as disclosed herein. The configuration component 725 is capable of, configured to, or operable to support a means for identifying a configuration that indicates to cycle between a first power state and a second power state, and indicates a first subset of a set of multiple control channels that the UE is triggered by an LP-WUS to monitor during the first power state, where the first power state is associated with higher power consumption than the second power state. The LP-WUS component 730 is capable of, configured to, or operable to support a means for receiving the LP-WUS that triggers the UE to monitor the first subset of the set of multiple control channels based on the configuration. The control channel component 735 is capable of, configured to, or operable to support a means for monitoring, using the first power state, the first subset of the set of multiple control channels for one or more control messages based on the configuration and reception of the LP-WUS.

In some examples, to support identifying the configuration, the control signaling component 740 is capable of, configured to, or operable to support a means for receiving control signaling that indicates the configuration, where the LP-WUS is received based on reception of the control signaling, and where the first subset of the set of multiple control channels is monitored based on reception of the control signaling.

In some examples, to support identifying the configuration, the configuration component 725 is capable of, configured to, or operable to support a means for identifying a first configuration that indicates the first subset of the set of multiple control channels that the UE is triggered by the LP-WUS to monitor during the first power state. In some examples, to support identifying the configuration, the control signaling component 740 is capable of, configured to, or operable to support a means for receiving control signaling that indicates a second configuration, where the second configuration indicates a second subset of the set of multiple control channels that the UE is triggered by the LP-WUS or a second LP-WUS to monitor during the first power state.

In some examples, the first subset of the set of multiple control channels and the second subset of the set of multiple control channels include one or more control channels in common. In some examples, the second configuration overwrites the first configuration, or both.

In some examples, the first configuration indicates a first set of one or more parameters and the second configuration indicates a second set of one or more parameters.

In some examples, the configuration indicates one or more CORESET IDs. In some examples, the first subset of the set of multiple control channels is based on the one or more CORESET IDs.

In some examples, the configuration indicates one or more search space sets. In some examples, the first subset of the set of multiple control channels is based on the one or more search space sets.

In some examples, the configuration indicates one or more search space set types. In some examples, the first subset of the set of multiple control channels is based on the one or more search space set types.

In some examples, the configuration indicates one or more RNTI types. In some examples, the first subset of the set of multiple control channels is based on the one or more RNTI types.

In some examples, the configuration indicates one or more control message formats. In some examples, the first subset of the set of multiple control channels is based on the one or more control message formats.

In some examples, the configuration indicates one or more parameters. In some examples, the first subset of the set of multiple control channels is based on the one or more parameters. In some examples, the one or more parameters include one or more CORESET IDs, one or more search space sets, one or more search space set types, one or more RNTI types, one or more control message formats, or a combination thereof.

In some examples, the first subset of the set of multiple control channels is a single control channel.

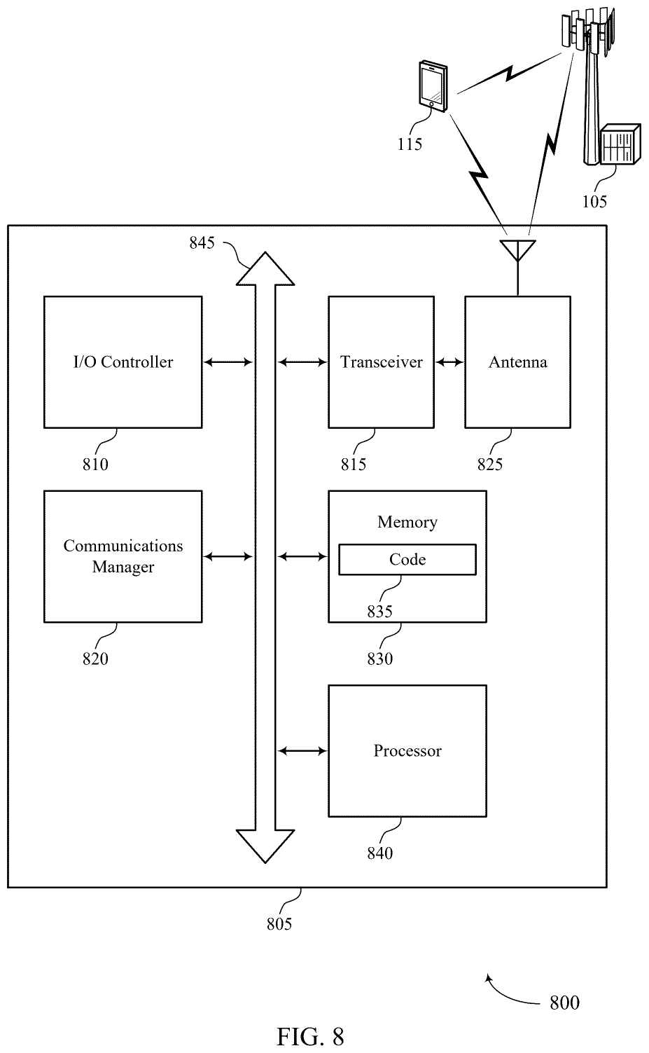

FIG. 8 shows a diagram of a system 800 including a device 805 that supports LP-WUSs for PDCCH monitoring in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting LP-WUSs for PDCCH monitoring). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein (e.g., according to one or more processor-readable instructions). In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for identifying a configuration that indicates to cycle between a first power state and a second power state, and indicates a first subset of a set of multiple control channels that the UE is triggered by an LP-WUS to monitor during the first power state, where the first power state is associated with higher power consumption than the second power state. The communications manager 820 is capable of, configured to, or operable to support a means for receiving the LP-WUS that triggers the UE to monitor the first subset of the set of multiple control channels based on the configuration. The communications manager 820 is capable of, configured to, or operable to support a means for monitoring, using the first power state, the first subset of the set of multiple control channels for one or more control messages based on the configuration and reception of the LP-WUS.

By including or configuring the communications manager 820 in accordance with examples as described herein, the device 805 may support techniques for reduced latency, improved user experience related to reduced processing, reduced power consumption, more efficient utilization of communication resources, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of LP-WUSs for PDCCH monitoring as described herein, or the at least one processor 840 and the at least one memory 830 may be otherwise configured to, individually or collectively, perform or support such operations.

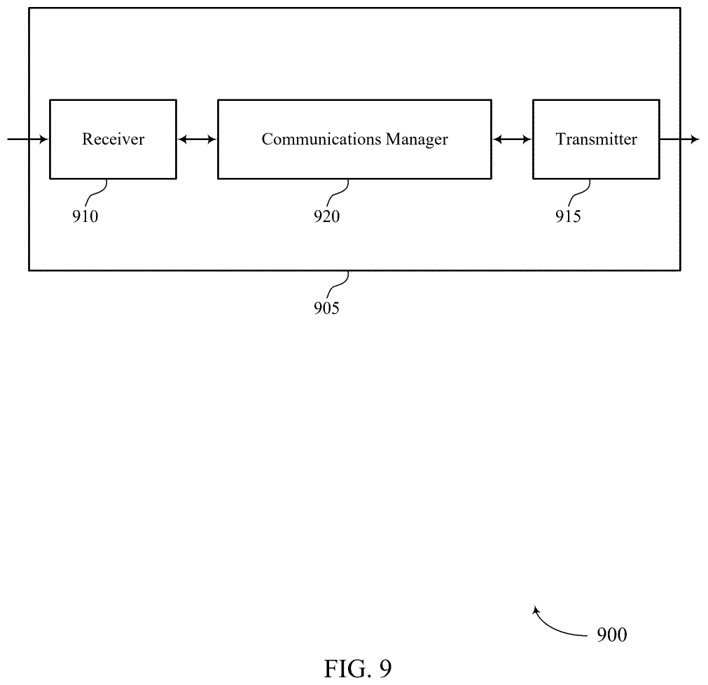

FIG. 9 shows a block diagram 900 of a device 905 that supports LP-WUSs for PDCCH monitoring in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of LP-WUSs for PDCCH monitoring as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing one or more processor-readable instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for identifying a configuration that indicates a UE to cycle between a first power state and a second power state, and indicates a first subset of a set of multiple control channels that the UE is triggered by an LP-WUS to monitor during the first power state, where the first power state is associated with higher power consumption than the second power state. The communications manager 920 is capable of, configured to, or operable to support a means for outputting the LP-WUS that triggers the UE to monitor the first subset of the set of multiple control channels based on the configuration. The communications manager 920 is capable of, configured to, or operable to support a means for outputting one or more control messages via the first subset of the set of multiple control channels based on the configuration and the LP-WUS.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

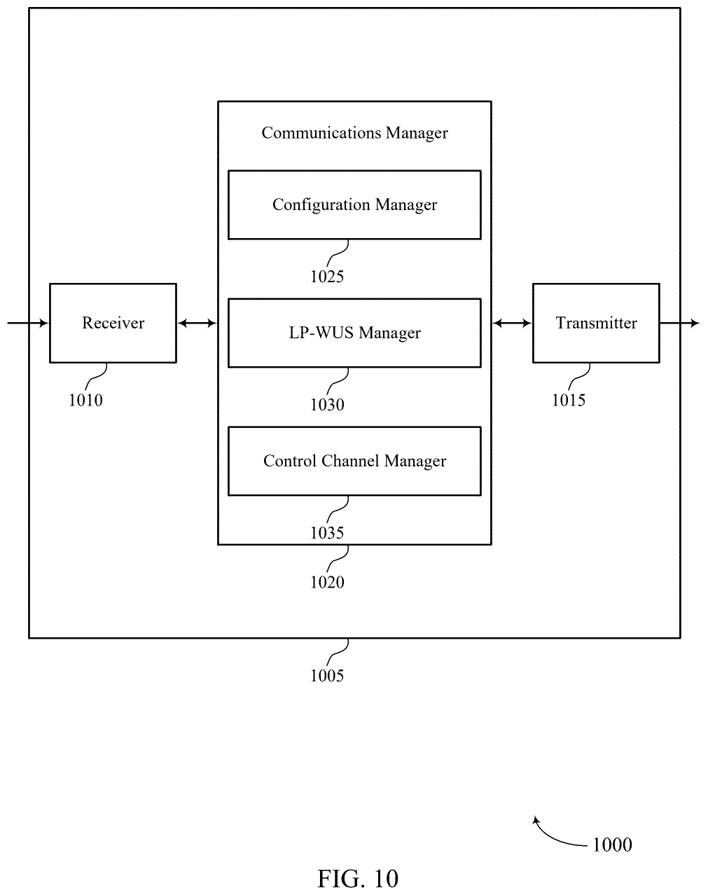

FIG. 10 shows a block diagram 1000 of a device 1005 that supports LP-WUSs for PDCCH monitoring in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of LP-WUSs for PDCCH monitoring as described herein. For example, the communications manager 1020 may include a configuration manager 1025, an LP-WUS manager 1030, a control channel manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for identifying a configuration that indicates a UE to cycle between a first power state and a second power state, and indicates a first subset of a set of multiple control channels that the UE is triggered by an LP-WUS to monitor during the first power state, where the first power state is associated with higher power consumption than the second power state. The LP-WUS manager 1030 is capable of, configured to, or operable to support a means for outputting the LP-WUS that triggers the UE to monitor the first subset of the set of multiple control channels based on the configuration. The control channel manager 1035 is capable of, configured to, or operable to support a means for outputting one or more control messages via the first subset of the set of multiple control channels based on the configuration and the LP-WUS.

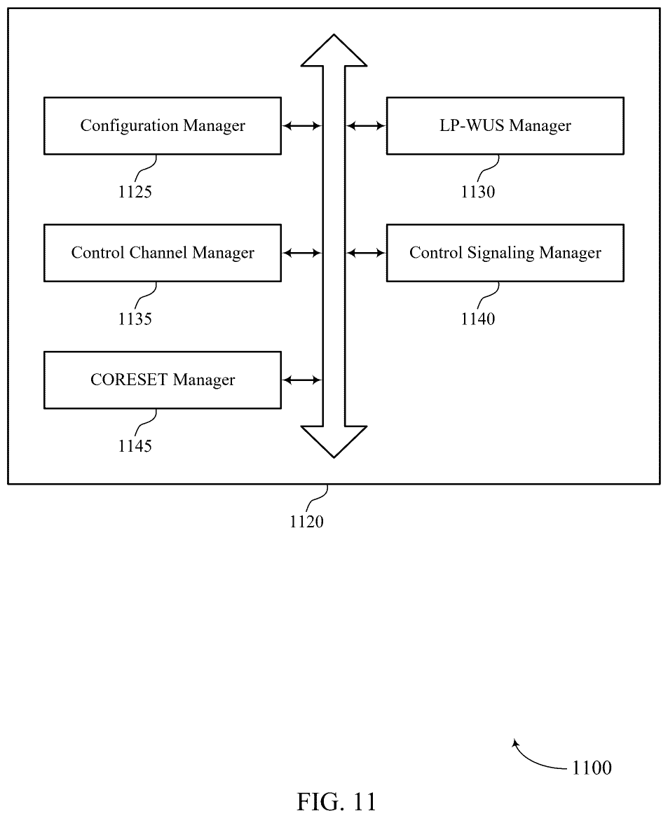

FIG. 11 shows a block diagram 1100 of a communications manager 1120 that supports LP-WUSs for PDCCH monitoring in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of LP-WUSs for PDCCH monitoring as described herein. For example, the communications manager 1120 may include a configuration manager 1125, an LP-WUS manager 1130, a control channel manager 1135, a control signaling manager 1140, a CORESET manager 1145, or any combination thereof. Each of these components, or components or subcomponents thereof (e.g., one or more processors, one or more memories, one or more processor-readable instructions), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for identifying a configuration that indicates a UE to cycle between a first power state and a second power state, and indicates a first subset of a set of multiple control channels that the UE is triggered by an LP-WUS to monitor during the first power state, where the first power state is associated with higher power consumption than the second power state. The LP-WUS manager 1130 is capable of, configured to, or operable to support a means for outputting the LP-WUS that triggers the UE to monitor the first subset of the set of multiple control channels based on the configuration. The control channel manager 1135 is capable of, configured to, or operable to support a means for outputting one or more control messages via the first subset of the set of multiple control channels based on the configuration and the LP-WUS.

In some examples, the control signaling manager 1140 is capable of, configured to, or operable to support a means for outputting control signaling that indicates the configuration, where the LP-WUS is output based on the control signaling, and where the one or more control messages is output via the first subset of the set of multiple control channels based on the control signaling.

In some examples, to support identifying the configuration, the configuration manager 1125 is capable of, configured to, or operable to support a means for identifying a first configuration that indicates the first subset of the set of multiple control channels that the UE is triggered by the LP-WUS to monitor during the first power state. In some examples, to support identifying the configuration, the control signaling manager 1140 is capable of, configured to, or operable to support a means for outputting control signaling that indicates a second configuration, where the second configuration indicates a second subset of the set of multiple control channels that the UE is triggered by the LP-WUS to monitor during the first power state.

In some examples, the first subset of the set of multiple control channels and the second subset of the set of multiple control channels include one or more control channels in common. In some examples, the second configuration overwrites the first configuration, or both.

In some examples, the first configuration indicates a first set of one or more parameters and the second configuration indicates a second set of one or more parameters.

In some examples, the configuration indicates one or more CORESET IDs. In some examples, the first subset of the set of multiple control channels is based on the one or more CORESET IDs.

In some examples, the CORESET manager 1145 is capable of, configured to, or operable to support a means for transmitting control signaling indicating a parameter for one or more CORESETs, the parameter indicating that one or more control channels associated with the one or more CORESETs is included in the first subset of the set of multiple control channels.

In some examples, the configuration indicates one or more search space sets. In some examples, the first subset of the set of multiple control channels is based on the one or more search space sets.

In some examples, the configuration indicates one or more search space set types. In some examples, the first subset of the set of multiple control channels is based on the one or more search space set types.

In some examples, the configuration indicates one or more RNTI types. In some examples, the first subset of the set of multiple control channels is based on the one or more RNTI types.

In some examples, the configuration indicates one or more control message formats. In some examples, the first subset of the set of multiple control channels is based on the one or more control message formats.

In some examples, the configuration indicates one or more parameters. In some examples, the first subset of the set of multiple control channels is based on the one or more parameters. In some examples, the one or more parameters include one or more CORESET IDs, one or more search space sets, one or more search space set types, one or more RNTI types, one or more control message formats, or a combination thereof.

In some examples, the first subset of the set of multiple control channels is a single control channel.

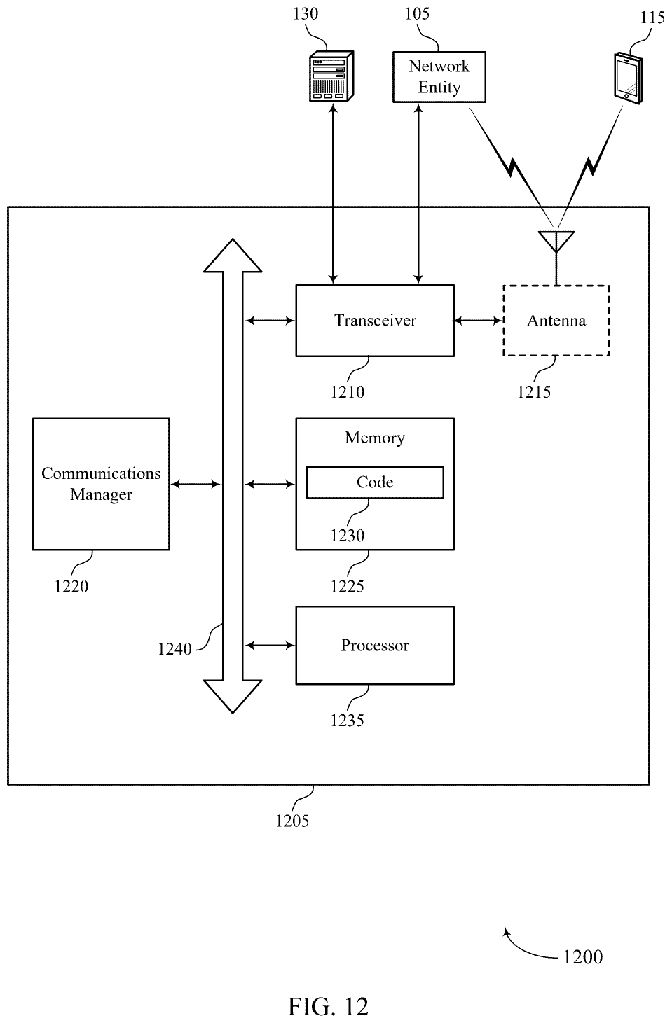

FIG. 12 shows a diagram of a system 1200 including a device 1205 that supports LP-WUSs for PDCCH monitoring in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system, in accordance with one or more processor-readable instructions).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting LP-WUSs for PDCCH monitoring). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for identifying a configuration that indicates a UE to cycle between a first power state and a second power state, and indicates a first subset of a set of multiple control channels that the UE is triggered by an LP-WUS to monitor during the first power state, where the first power state is associated with higher power consumption than the second power state. The communications manager 1220 is capable of, configured to, or operable to support a means for outputting the LP-WUS that triggers the UE to monitor the first subset of the set of multiple control channels based on the configuration. The communications manager 1220 is capable of, configured to, or operable to support a means for outputting one or more control messages via the first subset of the set of multiple control channels based on the configuration and the LP-WUS.

By including or configuring the communications manager 1220 in accordance with examples as described herein, the device 1205 may support techniques for reduced latency, improved user experience related to reduced processing, reduced power consumption, more efficient utilization of communication resources, improved coordination between devices, and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of LP-WUSs for PDCCH monitoring as described herein, or the at least one processor 1235 and the at least one memory 1225 may be otherwise configured to, individually or collectively, perform or support such operations.

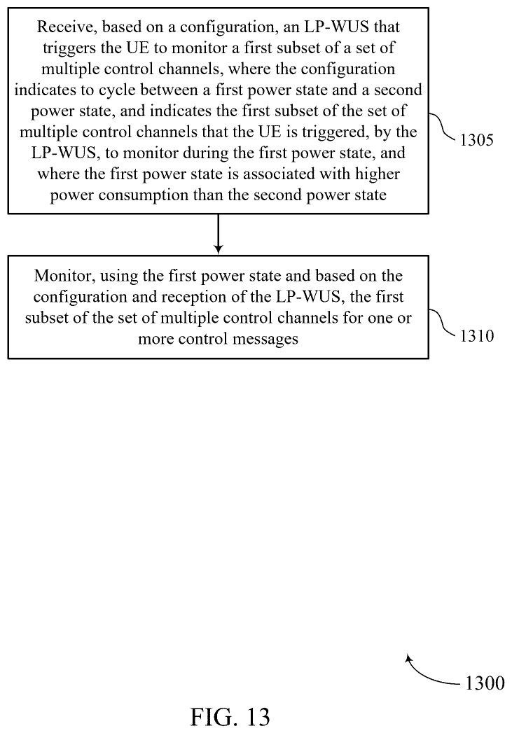

FIG. 13 shows a flowchart illustrating a method 1300 that supports LP-WUSs for PDCCH monitoring in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, based on a configuration, an LP-WUS that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state. The operations of 1305 may be performed in accordance with examples as disclosed herein, such as the reception of the LP-WUS 210 of FIG. 2, the reception of the LP-WUS 305 of FIG. 3, and the reception of the LP-WUS at 420 of FIG. 4. In some examples, aspects of the operations of 1305 may be performed by an LP-WUS component 730 as described with reference to FIG. 7.

At 1310, the method may include monitoring, using the first power state and based on the configuration and reception of the LP-WUS, the first subset of the set of multiple control channels for one or more control messages. The operations of 1310 may be performed in accordance with examples as disclosed herein, such as the monitoring of the control message 215 of FIG. 2, the monitoring of the PDCCH monitoring occasion 310 of FIG. 3, and the monitoring at 430 of FIG. 4. In some examples, aspects of the operations of 1310 may be performed by a control channel component 735 as described with reference to FIG. 7.

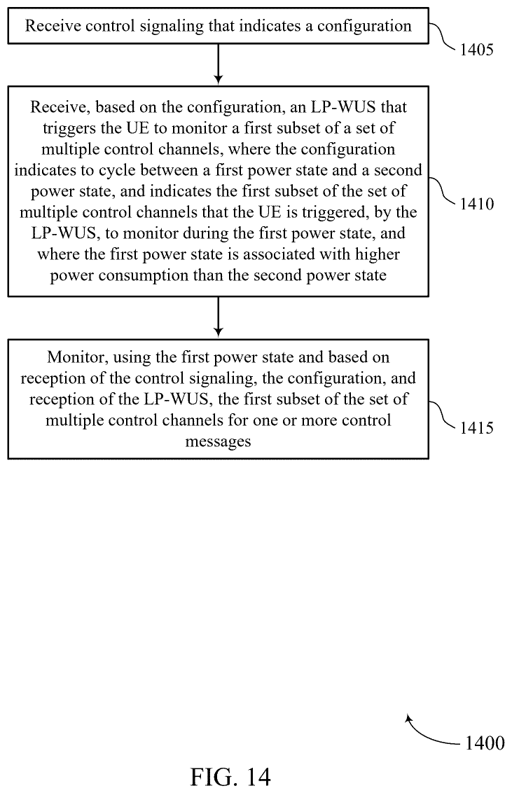

FIG. 14 shows a flowchart illustrating a method 1400 that supports LP-WUSs for PDCCH monitoring in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a configuration. The operations of 1405 may be performed in accordance with examples as disclosed herein, such as the reception of the configuration indication 205 of FIG. 2 and the reception of the configuration indication at 410 of FIG. 4. In some examples, aspects of the operations of 1405 may be performed by a control signaling component 740 as described with reference to FIG. 7.

At 1410, the method may include receiving, based on the configuration, an LP-WUS that triggers the UE to monitor a first subset of a set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state. The operations of 1410 may be performed in accordance with examples as disclosed herein, such as the reception of the LP-WUS 210 of FIG. 2, the reception of the LP-WUS 305 of FIG. 3, and the reception of the LP-WUS at 420 of FIG. 4. In some examples, aspects of the operations of 1410 may be performed by an LP-WUS component 730 as described with reference to FIG. 7.

At 1415, the method may include monitoring, using the first power state and based on reception of the control signaling, the configuration, and reception of the LP-WUS, the first subset of the set of multiple control channels for one or more control messages. The operations of 1415 may be performed in accordance with examples as disclosed herein, such as the monitoring of the control message 215 of FIG. 2, the monitoring of the PDCCH monitoring occasion 310 of FIG. 3, and the monitoring at 430 of FIG. 4. In some examples, aspects of the operations of 1415 may be performed by a control channel component 735 as described with reference to FIG. 7.

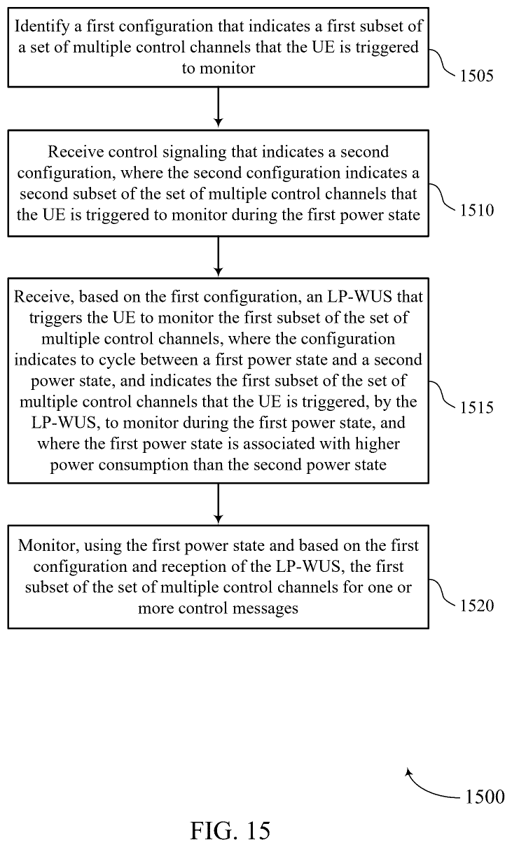

FIG. 15 shows a flowchart illustrating a method 1500 that supports LP-WUSs for PDCCH monitoring in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include identifying a first configuration that indicates a first subset of a set of multiple control channels that the UE is triggered to monitor. The operations of 1505 may be performed in accordance with examples as disclosed herein, such as the identification at 415 of FIG. 4. In some examples, aspects of the operations of 1505 may be performed by a configuration component 725 as described with reference to FIG. 7.

At 1510, the method may include receiving control signaling that indicates a second configuration, where the second configuration indicates a second subset of the set of multiple control channels that the UE is triggered to monitor during the first power state. The operations of 1510 may be performed in accordance with examples as disclosed herein, such as the reception of the configuration indication 205 of FIG. 2 and the reception of a configuration indication at 410 of FIG. 4. In some examples, aspects of the operations of 1510 may be performed by a control signaling component 740 as described with reference to FIG. 7.

At 1515, the method may include receiving, based on the first configuration, an LP-WUS that triggers the UE to monitor the first subset of the set of multiple control channels, where the configuration indicates to cycle between a first power state and a second power state, and indicates the first subset of the set of multiple control channels that the UE is triggered, by the LP-WUS, to monitor during the first power state, and where the first power state is associated with higher power consumption than the second power state. The operations of 1515 may be performed in accordance with examples as disclosed herein, such as the reception of the LP-WUS 210 of FIG. 2, the reception of the LP-WUS 305 of FIG. 3, and the reception of the LP-WUS at 420 of FIG. 4. In some examples, aspects of the operations of 1515 may be performed by an LP-WUS component 730 as described with reference to FIG. 7.

At 1520, the method may include monitoring, using the first power state and based on the first configuration and reception of the LP-WUS, the first subset of the set of multiple control channels for one or more control messages. The operations of 1520 may be performed in accordance with examples as disclosed herein, such as the monitoring of the control message 215 of FIG. 2, the monitoring of the PDCCH monitoring occasion 310 of FIG. 3, and the monitoring at 430 of FIG. 4. In some examples, aspects of the operations of 1520 may be performed by a control channel component 735 as described with reference to FIG. 7.

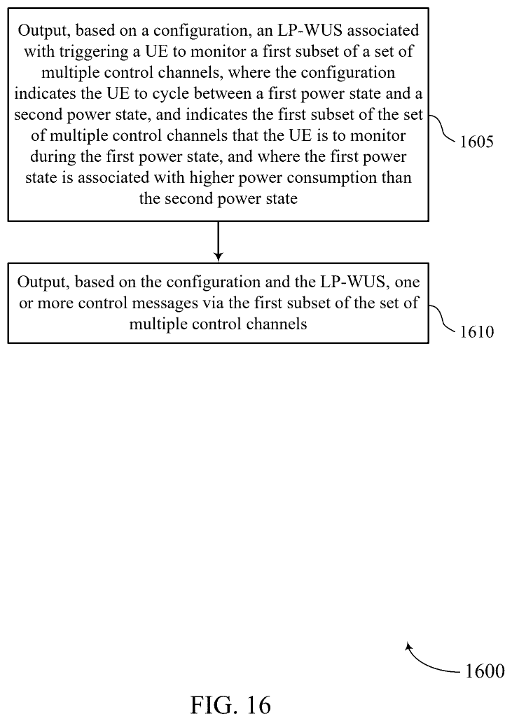

FIG. 16 shows a flowchart illustrating a method 1600 that supports LP-WUSs for PDCCH monitoring in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting, based on a configuration, an LP-WUS associated with triggering a UE to monitor a first subset of a set of multiple control channels, where the configuration indicates the UE to cycle between a first power state and a second power state, and indicates the first subset of the set of multiple control channels that the UE is to monitor during the first power state, and where the first power state is associated with higher power consumption than the second power state. The operations of 1605 may be performed in accordance with examples as disclosed herein, such as the transmission of the LP-WUS 210 of FIG. 2, the transmission of the LP-WUS 305 of FIG. 3, and the transmission of the LP-WUS at 420 of FIG. 4. In some examples, aspects of the operations of 1605 may be performed by an LP-WUS manager 1130 as described with reference to FIG. 11.

At 1610, the method may include outputting, based on the configuration and the LP-WUS, one or more control messages via the first subset of the set of multiple control channels. The operations of 1610 may be performed in accordance with examples as disclosed herein, such as the transmission of the control message 215 of FIG. 2 and the transmission of the control message at 425 of FIG. 4. In some examples, aspects of the operations of 1610 may be performed by a control channel manager 1135 as described with reference to FIG. 11.

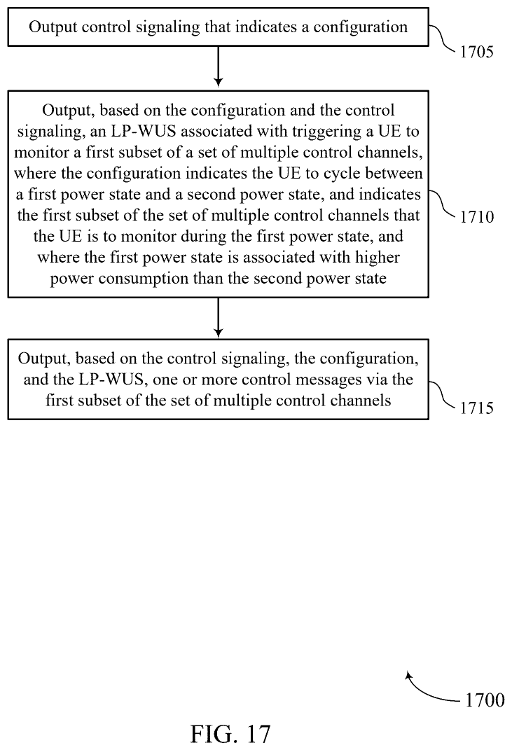

FIG. 17 shows a flowchart illustrating a method 1700 that supports LP-WUSs for PDCCH monitoring in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting control signaling that indicates a configuration. The operations of 1705 may be performed in accordance with examples as disclosed herein, such as the transmission of the configuration indication 205 of FIG. 2 and the transmission of the configuration indication at 410 of FIG. 4. In some examples, aspects of the operations of 1705 may be performed by a control signaling manager 1140 as described with reference to FIG. 11.

At 1710, the method may include outputting, based on the configuration and the control signaling, an LP-WUS associated with triggering a UE to monitor a first subset of a set of multiple control channels, where the configuration indicates the UE to cycle between a first power state and a second power state, and indicates the first subset of the set of multiple control channels that the UE is to monitor during the first power state, and where the first power state is associated with higher power consumption than the second power state. The operations of 1710 may be performed in accordance with examples as disclosed herein, such as the transmission of the LP-WUS 210 of FIG. 2, the transmission of the LP-WUS 305 of FIG. 3, and the transmission of the LP-WUS at 420 of FIG. 4. In some examples, aspects of the operations of 1710 may be performed by an LP-WUS manager 1130 as described with reference to FIG. 11.

At 1715, the method may include outputting, based on the control signaling, the configuration, and the LP-WUS, one or more control messages via the first subset of the set of multiple control channels. The operations of 1715 may be performed in accordance with examples as disclosed herein, such as the transmission of the control message 215 of FIG. 2 and the transmission of the control message at 425 of FIG. 4. In some examples, aspects of the operations of 1715 may be performed by a control channel manager 1135 as described with reference to FIG. 11.

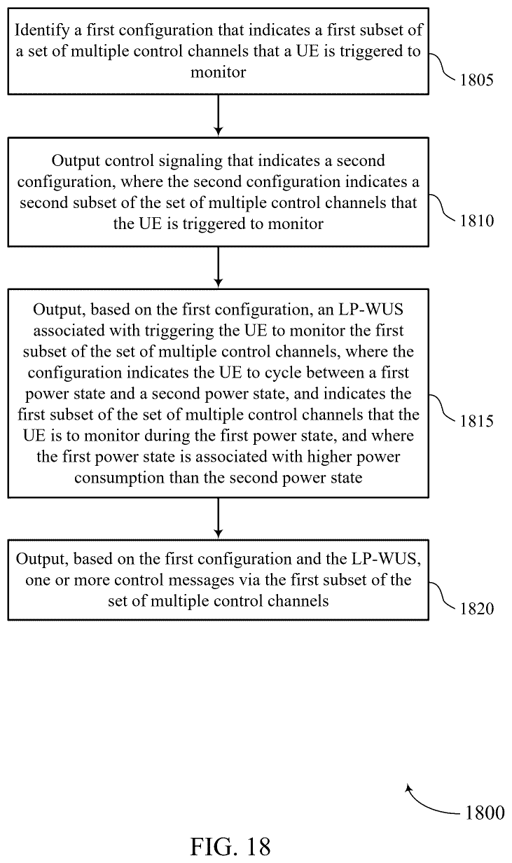

FIG. 18 shows a flowchart illustrating a method 1800 that supports LP-WUSs for PDCCH monitoring in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include identifying a first configuration that indicates a first subset of a set of multiple control channels that the UE is triggered to monitor. The operations of 1805 may be performed in accordance with examples as disclosed herein, such as the identification at 415 of FIG. 4. In some examples, aspects of the operations of 1805 may be performed by a configuration manager 1125 as described with reference to FIG. 11.

At 1810, the method may include outputting control signaling that indicates a second configuration, where the second configuration indicates a second subset of the set of multiple control channels that the UE is triggered to monitor. The operations of 1810 may be performed in accordance with examples as disclosed herein, such as the transmission of the configuration indication 205 of FIG. 2 and the transmission of the configuration indication at 410 of FIG. 4. In some examples, aspects of the operations of 1810 may be performed by a control signaling manager 1140 as described with reference to FIG. 11.

At 1815, the method may include outputting, based on the first configuration, an LP-WUS associated with triggering the UE to monitor the first subset of the set of multiple control channels, where the configuration indicates the UE to cycle between a first power state and a second power state, and indicates the first subset of the set of multiple control channels that the UE is to monitor during the first power state, and where the first power state is associated with higher power consumption than the second power state. The operations of 1815 may be performed in accordance with examples as disclosed herein, such as the transmission of the LP-WUS 210 of FIG. 2, the transmission of the LP-WUS 305 of FIG. 3, and the transmission of the LP-WUS at 420 of FIG. 4. In some examples, aspects of the operations of 1815 may be performed by an LP-WUS manager 1130 as described with reference to FIG. 11.

At 1820, the method may include outputting, based on the first configuration and the LP-WUS, one or more control messages via the first subset of the set of multiple control channels. The operations of 1820 may be performed in accordance with examples as disclosed herein, such as the transmission of the control message 215 of FIG. 2 and the transmission of the control message at 425 of FIG. 4. In some examples, aspects of the operations of 1820 may be performed by a control channel manager 1135 as described with reference to FIG. 11.

The following provides an overview of aspects of the present disclosure:

Aspect 1: A method for wireless communications at a UE, comprising: receiving, based at least in part on a configuration, a low-power wake-up signal that triggers the UE to monitor a first subset of a plurality of control channels, wherein the configuration indicates to cycle between a first power state and a second power state, and indicates the first subset of the plurality of control channels that the UE is triggered, by the low-power wake-up signal, to monitor during the first power state, and wherein the first power state is associated with higher power consumption than the second power state; and monitoring, using the first power state and based at least in part on the configuration and reception of the low-power wake-up signal, the first subset of the plurality of control channels for one or more control messages.

Aspect 2: The method of aspect 1, wherein identifying the configuration further comprises: receiving control signaling that indicates the configuration, wherein the low-power wake-up signal is received based at least in part on reception of the control signaling, and wherein the first subset of the plurality of control channels is monitored based at least in part on reception of the control signaling.

Aspect 3: The method of any of aspects 1 through 2, further comprising: identifying a first configuration that indicates the first subset of the plurality of control channels that the UE is triggered by the low-power wake-up signal to monitor during the first power state; and receiving control signaling that indicates a second configuration, wherein the second configuration indicates a second subset of the plurality of control channels that the UE is triggered by the low-power wake-up signal or a second low-power wake-up signal to monitor during the first power state.

Aspect 4: The method of aspect 3, wherein the first subset of the plurality of control channels and the second subset of the plurality of control channels comprise one or more control channels in common, the second configuration overwrites the first configuration, or both.

Aspect 5: The method of any of aspects 3 through 4, wherein the first configuration indicates a first set of one or more parameters and the second configuration indicates a second set of one or more parameters.

Aspect 6: The method of any of aspects 1 through 5, wherein the configuration indicates one or more control resource set (CORESET) identifiers, and the first subset of the plurality of control channels is based at least in part on the one or more CORESET identifiers.

Aspect 7: The method of any of aspects 1 through 6, wherein the configuration indicates one or more search space sets, and the first subset of the plurality of control channels is based at least in part on the one or more search space sets.

Aspect 8: The method of any of aspects 1 through 7, wherein the configuration indicates one or more search space set types, and the first subset of the plurality of control channels is based at least in part on the one or more search space set types.

Aspect 9: The method of any of aspects 1 through 8, wherein the configuration indicates one or more radio network temporary identifier (RNTI) types, and the first subset of the plurality of control channels is based at least in part on the one or more RNTI types.

Aspect 10: The method of any of aspects 1 through 9, wherein the configuration indicates one or more control message formats, and the first subset of the plurality of control channels is based at least in part on the one or more control message formats.

Aspect 11: The method of any of aspects 1 through 10, wherein the configuration indicates one or more parameters, and the first subset of the plurality of control channels is based at least in part on the one or more parameters, and the one or more parameters include one or more control resource set (CORESET) identifiers, one or more search space sets, one or more search space set types, one or more radio network temporary identifier (RNTI) types, one or more control message formats, or a combination thereof.

Aspect 12: The method of any of aspects 1 through 11, wherein the first subset of the plurality of control channels is a single control channel.

Aspect 13: A method for wireless communications at a network entity, comprising: outputting, based at least in part on a configuration, a low-power wake-up signal associated with triggering a UE to monitor a first subset of a plurality of control channels, wherein the configuration indicates the UE to cycle between a first power state and a second power state, and indicates the first subset of the plurality of control channels that the UE is to monitor during the first power state, and wherein the first power state is associated with higher power consumption than the second power state; and outputting, based at least in part on the configuration and the low-power wake-up signal, one or more control messages via the first subset of the plurality of control channels.

Aspect 14: The method of aspect 13, further comprising: outputting control signaling that indicates the configuration, wherein the low-power wake-up signal is output based at least in part on the control signaling, and wherein the one or more control messages is output via the first subset of the plurality of control channels based at least in part on the control signaling.

Aspect 15: The method of any of aspects 13 through 14, further comprising: identifying a first configuration that indicates the first subset of the plurality of control channels that the UE is triggered by the low-power wake-up signal to monitor during the first power state; and outputting control signaling that indicates a second configuration, wherein the second configuration indicates a second subset of the plurality of control channels that the UE is triggered by the low-power wake-up signal to monitor during the first power state.

Aspect 16: The method of aspect 15, wherein the first subset of the plurality of control channels and the second subset of the plurality of control channels comprise one or more control channels in common, the second configuration overwrites the first configuration, or both.

Aspect 17: The method of any of aspects 15 through 16, wherein the first configuration indicates a first set of one or more parameters and the second configuration indicates a second set of one or more parameters.

Aspect 18: The method of any of aspects 13 through 17, wherein the configuration indicates one or more control resource set (CORESET) identifiers, and the first subset of the plurality of control channels is based at least in part on the one or more CORESET identifiers.

Aspect 19: The method of any of aspects 13 through 18, further comprising: transmitting control signaling indicating a parameter for one or more control resource sets (CORESETs), the parameter indicating that one or more control channels associated with the one or more CORESETs is included in the first subset of the plurality of control channels.

Aspect 20: The method of any of aspects 13 through 19, wherein the configuration indicates one or more search space sets, and the first subset of the plurality of control channels is based at least in part on the one or more search space sets.

Aspect 21: The method of any of aspects 13 through 20, wherein the configuration indicates one or more search space set types, and the first subset of the plurality of control channels is based at least in part on the one or more search space set types.

Aspect 22: The method of any of aspects 13 through 21, wherein the configuration indicates one or more radio network temporary identifier (RNTI) types, and the first subset of the plurality of control channels is based at least in part on the one or more RNTI types.

Aspect 23: The method of any of aspects 13 through 22, wherein the configuration indicates one or more control message formats, and the first subset of the plurality of control channels is based at least in part on the one or more control message formats.

Aspect 24: The method of any of aspects 13 through 23, wherein the configuration indicates one or more parameters, and the first subset of the plurality of control channels is based at least in part on the one or more parameters, and the one or more parameters include one or more control resource set (CORESET) identifiers, one or more search space sets, one or more search space set types, one or more radio network temporary identifier (RNTI) types, one or more control message formats, or a combination thereof.

Aspect 25: The method of any of aspects 13 through 24, wherein the first subset of the plurality of control channels is a single control channel.

Aspect 26: A UE for wireless communications, comprising one or more processors, one or more memories coupled with the one or more processors, and one or more processor-readable instructions stored in the one or more memories and executable by the one or more processors individually or collectively to cause the UE to perform a method of any of aspects 1 through 12.

Aspect 27: A UE for wireless communications, comprising at least one means for performing a method of any of aspects 1 through 12.

Aspect 28: A non-transitory computer-readable medium storing code for wireless communications, the code comprising instructions executable by one or more processors to perform a method of any of aspects 1 through 12.

Aspect 29: A network entity for wireless communications, comprising one or more processors, one or more memories coupled with the one or more processors, and one or more processor-readable instructions stored in the one or more memories and executable by the one or more processors individually or collectively to cause the network entity to perform a method of any of aspects 13 through 25.

Aspect 30: A network entity for wireless communications, comprising at least one means for performing a method of any of aspects 13 through 25.

Aspect 31: A non-transitory computer-readable medium storing code for wireless communications, the code comprising instructions executable by one or more processors to perform a method of any of aspects 13 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more processors;
one or more memories coupled with the one or more processors; and
one or more processor-readable instructions stored in the one or more memories and executable by the one or more processors individually or collectively to cause the UE to:
receive, based at least in part on a configuration, a low-power wake-up signal that triggers the UE to monitor a first subset of a plurality of control channels, wherein the configuration indicates to cycle between a first power state and a second power state, and indicates the first subset of the plurality of control channels that the UE is triggered, by the low-power wake-up signal, to monitor during the first power state, and wherein the first power state is associated with higher power consumption than the second power state; and
monitor, using the first power state and based at least in part on the configuration and reception of the low-power wake-up signal, the first subset of the plurality of control channels for one or more control messages.

2. The UE of claim 1, wherein the one or more processor-readable instructions are further executable by the one or more processors individually or collectively to cause the UE to:
receive control signaling that indicates the configuration, wherein the low-power wake-up signal is received based at least in part on reception of the control signaling, and wherein the first subset of the plurality of control channels is monitored based at least in part on reception of the control signaling.

3. The UE of claim 1, wherein the one or more processor-readable instructions are further executable by the one or more processors individually or collectively to cause the UE to:
identify a first configuration that indicates the first subset of the plurality of control channels that the UE is triggered to monitor; and
receive control signaling that indicates a second configuration, wherein the second configuration indicates a second subset of the plurality of control channels that the UE is triggered to monitor during the first power state.

4. The UE of claim 3, wherein the first subset of the plurality of control channels and the second subset of the plurality of control channels comprise one or more control channels in common, the second configuration overwrites the first configuration, or both.

5. The UE of claim 3, wherein the first configuration indicates a first set of one or more parameters and the second configuration indicates a second set of one or more parameters.

6. The UE of claim 1, wherein the configuration indicates one or more control resource set (CORESET) identifiers, and the first subset of the plurality of control channels is based at least in part on the one or more CORESET identifiers.

7. The UE of claim 1, wherein the configuration indicates one or more search space sets, and the first subset of the plurality of control channels is based at least in part on the one or more search space sets.

8. The UE of claim 1, wherein the configuration indicates one or more search space set types, and the first subset of the plurality of control channels is based at least in part on the one or more search space set types.

9. The UE of claim 1, wherein the configuration indicates one or more radio network temporary identifier (RNTI) types, and the first subset of the plurality of control channels is based at least in part on the one or more RNTI types.

10. The UE of claim 1, wherein the configuration indicates one or more control message formats, and the first subset of the plurality of control channels is based at least in part on the one or more control message formats.

11. The UE of claim 1, wherein the configuration indicates one or more parameters, and the first subset of the plurality of control channels is based at least in part on the one or more parameters, and the one or more parameters include one or more control resource set (CORESET) identifiers, one or more search space sets, one or more search space set types, one or more radio network temporary identifier (RNTI) types, one or more control message formats, or a combination thereof.

12. The UE of claim 1, wherein the first subset of the plurality of control channels is a single control channel.

13. A method for wireless communications at a user equipment (UE), comprising:
receiving, based at least in part on a configuration, a low-power wake-up signal that triggers the UE to monitor a first subset of a plurality of control channels, wherein the configuration indicates to cycle between a first power state and a second power state, and indicates the first subset of the plurality of control channels that the UE is triggered, by the low-power wake-up signal, to monitor during the first power state, and wherein the first power state is associated with higher power consumption than the second power state; and
monitoring, using the first power state and based at least in part on the configuration and reception of the low-power wake-up signal, the first subset of the plurality of control channels for one or more control messages.

14. The method of claim 13, further comprising:
receiving control signaling that indicates the configuration, wherein the low-power wake-up signal is received based at least in part on reception of the control signaling, and wherein the first subset of the plurality of control channels is monitored based at least in part on reception of the control signaling.

15. The method of claim 13, further comprising:
identifying a first configuration that indicates the first subset of the plurality of control channels that the UE is triggered to monitor; and
receiving control signaling that indicates a second configuration, wherein the second configuration indicates a second subset of the plurality of control channels that the UE is triggered to monitor during the first power state.

16. The method of claim 13, wherein the configuration indicates one or more control resource set (CORESET) identifiers, and the first subset of the plurality of control channels is based at least in part on the one or more CORESET identifiers.

17. The method of claim 13, wherein the configuration indicates one or more search space sets, and the first subset of the plurality of control channels is based at least in part on the one or more search space sets.

18. The method of claim 13, wherein the configuration indicates one or more search space set types, and the first subset of the plurality of control channels is based at least in part on the one or more search space set types.

19. A non-transitory computer-readable medium storing code for wireless communications at a user equipment (UE), the code comprising instructions executable by one or more processors to:
receive, based at least in part on a configuration, a low-power wake-up signal that triggers the UE to monitor a first subset of a plurality of control channels, wherein the configuration indicates to cycle between a first power state and a second power state, and indicates the first subset of the plurality of control channels that the UE is triggered, by the low-power wake-up signal, to monitor during the first power state, and wherein the first power state is associated with higher power consumption than the second power state; and
monitor, using the first power state and based at least in part on the configuration and reception of the low-power wake-up signal, the first subset of the plurality of control channels for one or more control messages.

20. The non-transitory computer-readable medium of claim 19, wherein the instructions are further executable by the one or more processors to:
receive control signaling that indicates the configuration, wherein the low-power wake-up signal is received based at least in part on reception of the control signaling, and wherein the first subset of the plurality of control channels is monitored based at least in part on reception of the control signaling.
